(19) United States
(12) Patent Application Publication
(10) Pub. No.: US 2025/0348954 A1
(43) Pub. Date: Nov. 13, 2025

(54) ClapbackForJustice, a method for analyzing and countering harmful racial content and racial misinformation in online discourse using AI.

(71) Applicant: Whitney Mariena Kotlewski, Rancho Cucamonga, CA (US)

(72) Inventor: Whitney Mariena Kotlewski, Rancho Cucamonga, CA (US)

(21) Appl. No.: 19/087,454

(22) Filed: Mar. 22, 2025

Related U.S. Application Data
(60) Provisional application No. 63/571,202, filed on Mar. 28, 2024.

(51) Int. Cl. G06Q 50/00; G06Q 50/26

(52) U.S. Cl. CPC G06Q 50/01; G06Q 50/265

(57) ABSTRACT

ClapbackForJustice, a method for analyzing and countering racially charged content during online discourse using AI, is disclosed. By integrating the novel Integrated Framework for Assessing Racial Discourse (IFARD) and custom AI models with a targeted Racial Justice Data Library, the invention adeptly identifies hate speech, harm, toxicity, the usage of stereotypes, and misinformation. IFARD and ChatGPT stand at the core of this method, enabling the generation of precise, context-aware counterarguments that effectively challenge, correct, shape, and inform racial discourse. By deploying insights from the IFARD framework and the Racial Justice Data Library, the invention tackles the nuances of hate speech and coded racism. It equips and educates users with accurate, historical, and contextual information, thus promoting a deeper understanding and awareness of racial justice issues.

### BACKGROUND OF THE INVENTION

Problem Solved: The invention tackles the widespread issue of racially charged content, including racial misinformation, biases, hate speech, harm, and toxicity, prevalent in social media discourse. This content distorts public perception, fuels stereotypes, inflicts racial battle fatigue and harm, and exacerbates social divisions. It particularly impacts African Americans and, potentially, other demographic groups.

Existing methods, such as those employed by platforms like Facebook and Twitter, often rely on simple keyword filters or generic AI models. These approaches lack the nuanced understanding necessary to accurately identify and address harmful racial content and racial misinformation, particularly missing the historical, social, and cultural contexts that shape such discourse. As a result, they tend to produce overgeneralized responses that overlook the subtleties of hate speech, coded racism, and implicit biases in racial discourse. This shortfall not only prevents them from effectively mitigating the spread of racial misinformation but also leaves them unable to prevent social harm and racial battle fatigue stemming from these limitations. Consequently, these systems fail to foster positive changes in online discourse, allowing the perpetuation of stereotypes, harm, and exacerbation of social divisions.

This invention introduces the novel Integrated Framework for Assessing Racial Discourse (IFARD), a groundbreaking approach that, in combination with custom AI models and a dedicated Racial Justice Data Library, adeptly identifies hate speech, harm, toxicity, the usage of stereotypes, and racial misinformation. IFARD and ChatGPT stand at the core of this system, enabling the generation of precise, context-aware counterarguments to challenge racially charged content. By deploying insights from the Racial Justice Data Library, the invention not only tackles racial misinformation but also educates users with accurate, historical, and contextual information, thus promoting a deeper understanding and awareness of racial justice issues.

### DETAILED DESCRIPTION OF THE INVENTION

As stated above, the invention addresses the pervasive challenge of social harm caused by racially charged content and racial misinformation within online discourse, which distorts public perception, fuels stereotypes, and exacerbates social divisions, particularly affecting African Americans and potentially other demographic groups. The invention claimed here solves this problem.

The invention employs a methodical process, integrating the Integrated Framework for Assessing Racial Discourse (IFARD) with custom AI models to meticulously analyze online content for hate speech, harm, toxicity, the usage of stereotypes, and racial misinformation. This integration allows for a dual-layered analysis where IFARD provides a structured framework for evaluating content based on sociological, contextual, and psychological criteria, while AI models offer scalable, automated analysis capable of processing vast quantities of data. By leveraging a comprehensive Racial Justice Data Library for data insights and a custom GPT Fact Check model for accurate fact-checking, it generates an informed counterargument. A counterargument provides context to the user as to what issues were wrong with the content submitted. This counterargument is rigorously evaluated for quality before being presented, effectively challenging, and correcting any issues with the problematic content, thus fostering a more informed and respectful online discourse.

The claimed invention differs from what currently exists. The invention surpasses existing solutions by combining AI and IFARD with a specialized Racial Justice Data Library for data insights, uniquely enabling nuanced detection and correction of hate speech, coded language, toxicity, and racial misinformation. Its integration of comprehensive fact-checking and quality-assured counterargument generation offers an unprecedented approach to enhancing the accuracy and constructiveness of online racial discourse.

This invention improves on what currently exists. It surpasses existing solutions by combining AI and IFARD with a specialized Racial Justice Data Library for data insights, uniquely enabling nuanced detection and correction of hate speech, coded language, and racial misinformation. Its integration of comprehensive fact-checking and quality-assured counterargument generation offers an unprecedented approach to enhancing the accuracy and constructiveness of online racial discourse.

Their ineffectiveness is often due to a limited capacity to accurately identify and classify specific nuances in stereotypes, hate speech, coded language, and misinformation used against people of color, failing to capture the specific historical, cultural, and contextual subtleties that inform racial discourse.

By integrating the sophisticated IFARD process and custom AI models with a targeted Racial Justice Data Library, the invention adeptly identifies and classifies specific nuances in stereotypes, hate speech, coded language, and misinformation, enabling the generation of precise, context-aware counterarguments that effectively challenge, correct, shape, and inform racial discourse. Moreover, through the deployment of data insights from the Racial Justice Data Library, the invention not only corrects misinformation but also educates users with accurate, historical, and contextual information, fostering a broader understanding and awareness of racial justice issues.

Also, it can produce and enable the creation and deployment of diverse products and tools across various sectors, focusing on enhancing information accuracy, promoting education, and enriching public discourse. This approach not only tackles racial injustices but also extends its capabilities to combat a wide range of social injustices, including those related to gender, age, disability, and more:

Digital Literacy Education Modules: Product: Interactive online modules that leverage the method to teach digital literacy, critical thinking, and the importance of fact-checking, designed for educational institutions and public awareness campaigns.

Health Misinformation Apps: Product: Mobile applications that apply the method to identify and counter health-related social injustices, providing users with verified information on medical topics, health policies, and preventive measures.

Corporate Reputation Software: Product: Custom software solutions for businesses to monitor and correct social injustices about their brands or products online, ensuring brand integrity and consumer trust through accurate information dissemination.

Political Fact-Checking Platforms: Product: Online platforms or tools that utilize the method to fact-check political statements and campaign information, offering the public access to unbiased and accurate political insights.

Environmental Advocacy Tools: Product: Digital tools and apps designed to counter environmental social injustices, promoting accurate information about climate change, sustainability practices, and environmental policies that impact communities.

Multilingual Information Accuracy Systems: Product: Systems that extend the method to operate in multiple languages, aimed at combating social injustices globally, ensuring wide access to factual content across different linguistic communities.

Automated Moderation Solutions for Online Platforms: Product: Integration solutions for social media platforms and forums, using the method to automatically identify and address racism and any other social injustice, maintaining healthier online spaces.

### The Version of the Invention Discussed Here Includes

User Interface (UI) Access and Content Submission
Content Classification and Keyword Categorization
Activation of Custom GPT AI Models
IFARD AI Model for In-Depth Racial Misinformation Analysis
Accessing Racial Justice Data Library for Supporting Information
Leveraging Social Media and News Articles for Fact-Checking
Crafting Responses with Counterargument Generation Module and Quality Assurance by GPT Rater
Presentation of Counterarguments and Data Visualizations to User
User Feedback and Reporting System Engagement
Continuous Learning and Model Adjustment Process
Bias Mitigation Algorithms Application

### Relationship Between The Components

User Interface (UI) Access and Content Submission: User initiates the interaction by submitting content through an UI, suspected of containing racially charged content or exhibiting racial misinformation, biases, hate speech, harm, and toxicity, prevalent in social media discourse. The UI is designed for ease of access, featuring intuitive navigation and a simple two-step process for content submission: 1) generating a counterargument called a clapback; and 2) posting the clapback to their social media, ensuring accessibility for users from diverse backgrounds.

Content Classification and Keyword Categorization: Immediately following content submission via an UI (Step 1), the method undertakes the task of classifying and categorizing the submitted content using keywords and descriptors. This pivotal step, informed by the initial submission, prepares the content for a more nuanced analysis by focusing on the potential presence of racial misinformation, biases, hate speech, harm, and toxicity. This categorization directly feeds into the next step, activating the Custom GPT AI Models (Step 3) for preliminary analysis with a refined focus.

Activation of Custom GPT AI Models: Utilizing the insights gained from the content classification and keyword categorization in Step 2, the method activates Custom GPT AI Models. These models are specifically designed to conduct a preliminary analysis of the categorized content, searching for indicators of racial misinformation, biases, hate speech, harm, and toxicity. The outcome of this analysis provides a foundational understanding that enhances the efficacy of the IFARD AI model's subsequent in-depth evaluation (Step 4).

IFARD AI Model for Content Analysis: Building on the preliminary findings from Step 3, the IFARD AI model embarks on a comprehensive analysis of the content, employing a sophisticated framework. This step involves a comprehensive analysis covering contextual evaluation, hate speech intensity assessment, language and contextual shifts evaluation, and toxicity level identification.

Racial Justice Data Library AI Model: In parallel with the IFARD AI model's analysis (Step 4), another AI model accesses the Racial Justice Data Library. This model extracts relevant data and insights, enriching the analysis with supporting factual information and generating data visualizations that highlight key findings, thus enhancing the interpretability and impact of the information presented.

Fact-Checking AI Model: Leveraging both the detailed content analysis from the IFARD AI model (Step 4) and the insights from the Racial Justice Data Library (Step 5), the fact-checking AI model verifies the accuracy of the content and formulated counterargument against reliable social media and news articles. This ensures that the response is not only grounded in verified facts but also resonates with broader societal narratives.

Crafting Responses and Quality Assurance: The analyses conducted by the IFARD AI model (Step 4), supported by data from the Racial Justice Data Library (Step 5) and validated through fact-checking (Step 6), converge as the Counterargument Generation Module, alongside the GPT Rater, crafts and refines the counterargument. This step guarantees that the response is accurate, informative, and adheres to high-quality standards before presentation to the user.

Presentation of Counterarguments and Data Visualizations to User: Upon completing the crafting and quality assurance process (Step 7), the refined counterargument and accompanying report with insights and data visualizations are displayed to the user through an UI. This presentation provides the user with clear, engaging, and informative responses to the original content.

User Feedback and Reporting System Engagement: The user is encouraged to engage with the counterargument and visualizations, offering feedback that is invaluable for the method's ongoing refinement. This feedback (collected in Step 8) directly informs the Continuous Learning and Model Adjustment Process (Step 10), ensuring the method evolves in response to user interactions and emerging trends.

Continuous Learning and Model Adjustment Process: Informed by user feedback (Step 9) and new data, this process continually refines the AI models and their analyses, including the application of Bias Mitigation Algorithms (Step 11), to enhance the system's accuracy, fairness, and adaptability over time.

Bias Mitigation Algorithms Application: To ensure fairness and accuracy throughout the process, Bias Mitigation Algorithms are applied, critically assessing each AI model's operation (highlighted in Steps 3, 4, 5, and 6) to identify and correct any biases in the analyses or generated content, thus reinforcing the method's integrity.

### How The Invention Works

Each step in the process, from initial content submission to the presentation of counterarguments and data visualizations, is meticulously designed to ensure accuracy, user engagement, and educational value, distinguishing this method from existing approaches. Initial Content Submission and Preliminary Checks: IF a user submits content through the user interface (UI), THEN check if the content is a parent or child post and assess if it includes imagery, video, or links for comprehensive context understanding.

Content Classification and Keyword Categorization: AFTER content submission is finalized, THEN categorize and classify content by keywords and descriptors, including stereotypical keyword classification and categorization using data library insights.

Activation of Custom GPT AI Models for Preliminary Analysis: IF preliminary checks are finalized, THEN activate Custom GPT AI Models to scrutinize the content for potential racial misinformation indicators.

IFARD AI Model for In-Depth Racial Misinformation Analysis: IF Custom GPT AI Models signal potential racial misinformation, THEN deploy the IFARD AI Model for comprehensive analysis, covering contextual evaluation, hate speech intensity assessment, language and contextual shifts evaluation, and toxicity level identification.

Fact-Checking and Validation with External Sources: IF insightful information is compiled, THEN employ the Fact-Checking AI Model to validate the information against reliable social media and news articles.

Counterargument Crafting and Quality Assurance: AFTER fact-checking corroborates the information's accuracy, THEN formulate counterargument and subject them to quality assurance checks using the Counterargument Generation Module coupled with the GPT Quality Rater.

User Report Generation: AFTER the counterargument has been crafted and have passed quality assurance, THEN generate a comprehensive user report that includes the analysis summary, counterargument, and data visualizations. This report is designed to provide the user with a detailed understanding of the analysis process, findings, and rationale behind the counterarguments.

Comprehensive Presentation to User: IF the user report is ready, THEN display the report to the user via the UI along with the counterargument and data visualizations, offering a clear, engaging, and informative response to the analyzed content.

Engagement and Feedback for Continuous Improvement: IF the user interacts with the presented content and offers feedback, THEN channel this feedback into the Continuous Learning and Model Adjustment Process, utilizing Bias Mitigation Algorithms to refine the process and continually enhance fairness and accuracy.

### How to Make the Invention

Create a tool to run the invention: You need some type of tool to grab the harmful racial content and racial misinformation to pull into the invention method.

Use IFARD or create a similar framework with similar constructs: Leverage the IFARD criteria for analyzing racially (or social) charged content in online discourse. This includes but is not limited to, a comprehensive analysis covering contextual evaluation, hate speech intensity assessment, language and contextual shifts evaluation, and toxicity level identification.

Develop Classification and Keyword Categorization Descriptors: Gather common or uncommon terms/stereotypes that are used against marginalized communities. Gather rich data insights related to social justice that are categorized by keywords.

Develop Custom GPT AI Models: Build AI models trained on datasets to recognize racial discourse nuances, misinformation, and data insights, including data visualizations.

Compile the Racial Justice Data Library: Gather verified data, historical insights, and research findings related to racial justice insights for analysis support.

Implement or Integrate Fact-Checking AI Model: Either develop a new AI model or integrate an existing one for verifying content against trusted sources like social media and news articles.

Design the User Interface (UI): Create an intuitive UI for content submission, counterargument presentation, and feedback collection.

Integrate Counterargument and Quality Assurance System Generate counterarguments based on IFARD analysis and Data Library insights with a GPT Rater for quality assurance.

Generate a report to display insights to users: Generate a report that consists of the IFARD analysis, the counterargument and the Racial Data Library insights and visualizations.

Establish Feedback and Continuous Improvement Mechanisms: Set up a user feedback system to refine AI models and the overall process, incorporating continuous learning and bias mitigation.

Conduct Testing and Refinement: Test the tool with real content to refine its effectiveness, adjusting based on feedback.

Deploy and Maintain: Launch the tool on a scalable platform and plan for regular updates and security checks.

Foster Community Engagement: Encourage user interaction to improve the tool's accuracy, relevance, and impact.

### Necessary Elements

IFARD Framework: Unique for addressing racial misinformation with specialized analysis.
Stereotypes Classification: Gather common or uncommon terms/stereotypes that are used against marginalized communities and classify them.
Custom GPT AI Models: Key for nuanced racial discourse analysis, racial justice data insights and visualizations and fact checking.
Racial Justice Data Library: Supports counterarguments with verified data insights and visualizations.
Fact-Checking AI Model: Verifies content accuracy.
User Interface (UI): Facilitates user interaction and content submission.
Counterargument and Quality Assurance: Ensures counterarguments meet quality standards.
Feedback and Improvement Mechanisms: Uses user feedback for continuous refinement.

### Optional Elements

Multilingual Support: Broadens accessibility. Community Engagement: Promotes discussion and understanding.
Improvements:
Real-Time Monitoring: Addresses harmful content and misinformation as it appears.
Advanced Bias Detection: Improves fairness and accuracy.
User Customization: Enhances engagement through personalization.
Educational Integration: Leverages the tool for learning about racial issues and media literacy.
Dynamic IFARD AI Model: Continuously updates with new analysis criteria for evolving racial misinformation, ensuring sustained effectiveness.
Interoperable Custom GPT AI Models: Seamlessly integrate with IFARD for nuanced analysis across demographics, enhancing response accuracy.
Expandable Data Library: IFARD dynamically links to an evolving Racial Justice Data Library, enriching fact-checking, and counterarguments.
Modular Fact-Checking: Works in tandem with IFARD for targeted verification, adaptable to various misinformation themes.
Adaptive UI: Configures based on IFARD insights, optimizing user engagement with counterarguments and visualizations.
AI-Driven Quality Assurance: Utilizes feedback loops between IFARD analysis, counterargument generation, and user responses to refine output quality.
Automated Feedback Mechanisms: IFARD AI leverages user feedback for system improvements, enabling faster adaptation.
Real-Time Monitoring with IFARD: Proactively identifies emerging misinformation, keeping the system ahead of trends.
Advanced Bias Detection: IFARDs continuous learning ensures evolving bias detection and mitigation, maintaining fairness.

### How to Use The Invention

User Interface (UI) Access and Content Submission: Users start by accessing a user-friendly interface or a similar system, accessible as a web platform, plugin, or mobile application. They submit content (or an automated system submits content) suspected of containing racially charged material, including text, links, images, and videos, and provide any additional context useful for analysis, such as the relationship to a broader conversation (parent or child post).

Content Classification and Keyword Categorization: Upon submission, the method begins with categorizing the content by keywords and descriptors to prepare for detailed analysis, emphasizing the detection of harmful racial content and racial misinformation.

Activation of Custom GPT AI Models: The Custom GPT AI Models are then activated, beginning the automated analysis process using the IFARD AI model. This model evaluates the content against predefined criteria to identify harmful racial content and racial misinformation effectively.

Accessing Racial Justice Data Library for Supporting Information: Simultaneously, the method taps into the Racial Justice Data Library, extracting relevant facts, historical contexts, and research findings. Data visualizations are created to highlight key insights and bolster the counterargument.

Fact-Checking Process: A dedicated AI model conducts fact-checking using social media and news articles, verifying the accuracy and reliability of the information and insights derived from the analysis.

Counterargument Generation and Quality Assurance: Informed counterargument is crafted based on the analysis, fact-checking results, and data insights. The counterargument undergoes a quality assurance review by the GPT Rater for accuracy, relevance, and sensitivity.

Presentation to the User: The refined counterargument, alongside the analysis report and supporting data visualizations, is presented through the UI. This comprehensive package educates users (or an automated tool) on the harmful racial content and racial misinformation identified in the submitted content, providing accurate and context-rich information.

User Feedback: Users are invited to offer feedback on the counterargument and the overall utility. This feedback is crucial for the continuous learning and improvement process, aiding in refining AI models and enhancing the method's effectiveness.

Continuous Learning and Improvement: Leveraging user feedback and new data, the method undergoes continuous learning, adjusting the AI models, IFARD criteria, and its approach to remain adept at combating evolving harmful racial content and racial misinformation.

Bias Mitigation Algorithms Application: Throughout the process, Bias Mitigation Algorithms are applied to ensure the analysis and generated content are fair and accurate, continually assessing and correcting any biases in the AI models' operation.

ClapbackFor Justice's method of using AI to analyze and counter harmful racial content and racial misinformation can be adapted across various sectors, emphasizing its process-oriented capabilities:

Educational Tools: Transformed into a digital literacy tool, it educates students on discerning harmful social content and social misinformation, fostering critical thinking skills by dissecting and debunking incorrect information.

Public Health Communication: Adapted to combat health misinformation, the method can clarify misconceptions around health crises, contributing to informed public health decisions.

Brand Integrity: Utilized by businesses to monitor and correct brand-related social misinformation, protecting reputation through accurate information dissemination.

Political Fact-Checking: Applied to political discourse, it enhances electoral processes by providing factual counterarguments to political misinformation.

Environmental Advocacy: Adapted to environmental misinformation, it supports climate change communication by debunking myths and promoting scientific facts.

Global Misinformation Counteraction: Expanded for multilingual use, it addresses misinformation worldwide, enhancing access to accurate information across language barriers.

Content Moderation: Integrated into social media as an automated system, it maintains healthier online communities by proactively identifying and mitigating harmful social content and misinformation.

The invention can create, analyze and counter harmful racial content and racial misinformation that can be adapted across various sectors, emphasizing its process-oriented capabilities:

Digital Literacy Education Modules: Product: Interactive online modules that leverage the method to teach digital literacy, critical thinking, and the importance of fact-checking, designed for educational institutions and public awareness campaigns.

Health Misinformation Apps: Product: Mobile applications that apply the method to identify and counter health-related harmful content and misinformation, providing users with verified information on medical topics, health policies, and preventive measures.

Corporate Reputation Software: Product: Custom software solutions for businesses to monitor and correct harmful content and misinformation about their brands or products online, ensuring brand integrity and consumer trust through accurate information dissemination.

Political Fact-Checking Platforms: Product: Online platforms or tools that utilize the method to fact-check political statements and campaign information, offering the public access to unbiased and accurate political insights.

Environmental Advocacy Tools: Product: Digital tools and apps designed to counter environmental harmful content and misinformation, promoting accurate information about climate change, sustainability practices, and environmental policies.

Multilingual Information Accuracy Systems: Product: Systems that extend the method to operate in multiple languages, aimed at combating harmful social content and social misinformation globally, ensuring wide access to factual content across different linguistic communities.

Automated Moderation Solutions for Online Platforms: Product: Integration solutions for social media platforms and forums, using the method to automatically identify and address harmful social content and social misinformation, maintaining healthier online spaces.

### BRIEF DESCRIPTION OF THE DRAWINGS

FIG. 1 Illustrates the user flow from content submission to the presentation of counterarguments.

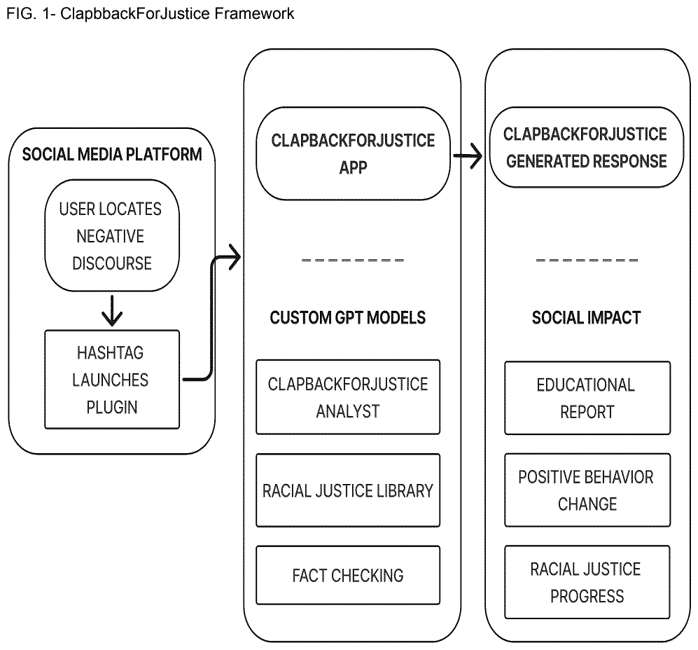

FIG. 2 Shows the structure and operation of the IFARD framework, highlighting how it evaluates submitted content.

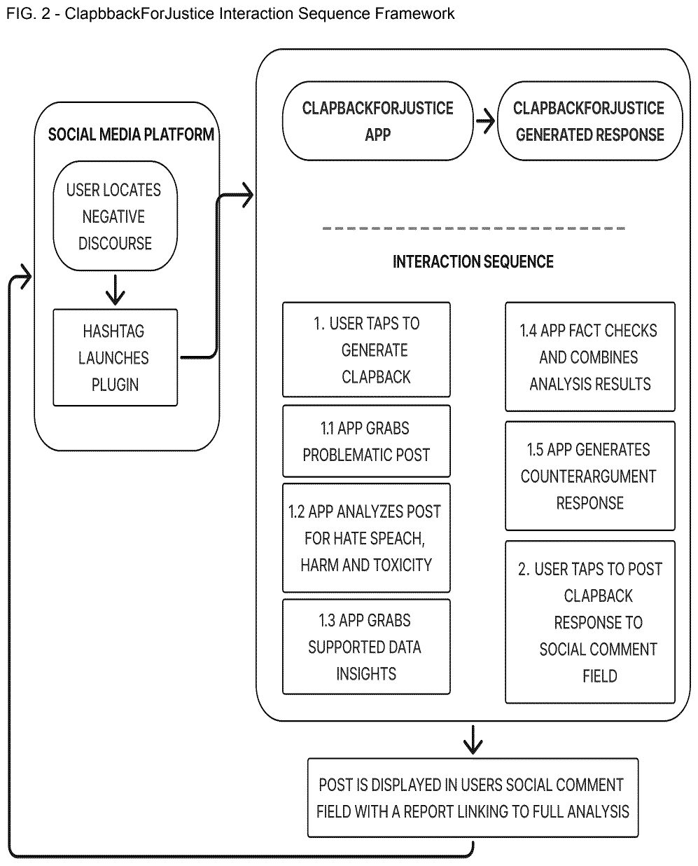

FIG. 3 Depicts the Racial Justice Data Library and how it integrates historical and contextual information into analysis.

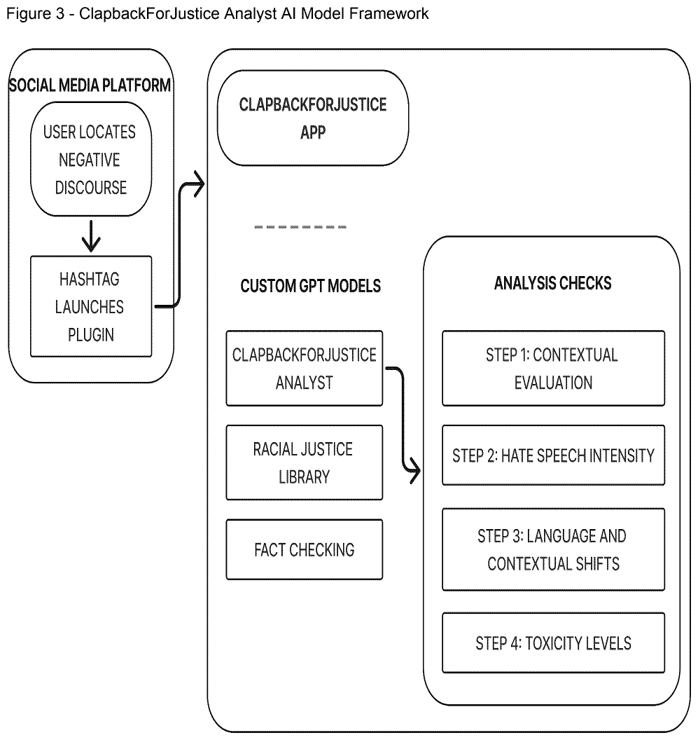

FIG. 4 Presents the fact-checking AI model's workflow for validating information.

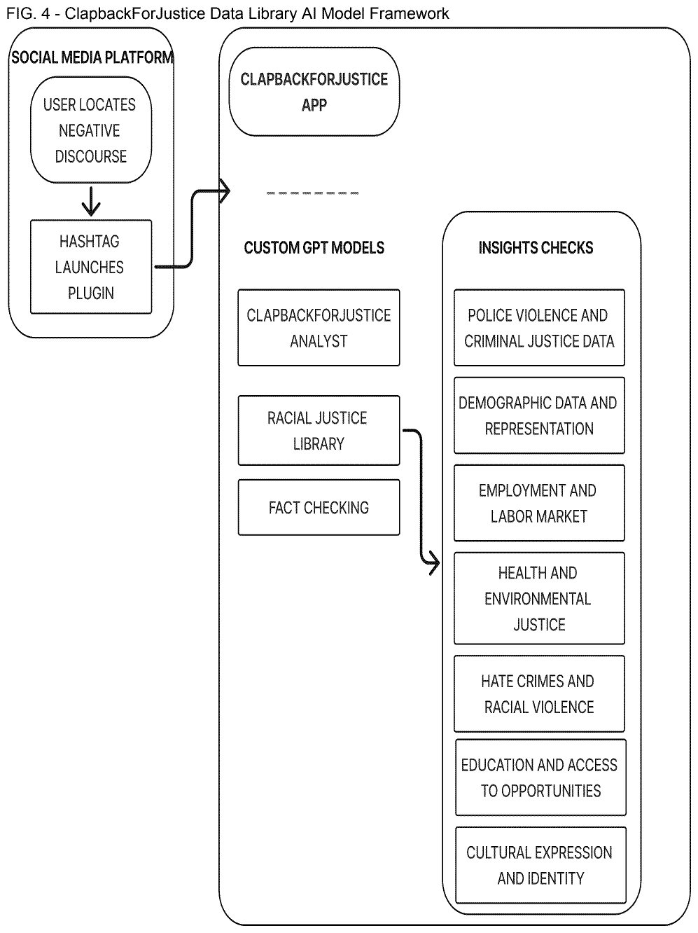

FIG. 5 Illustrates the counterargument generation and quality assurance process involving the GPT Rater.

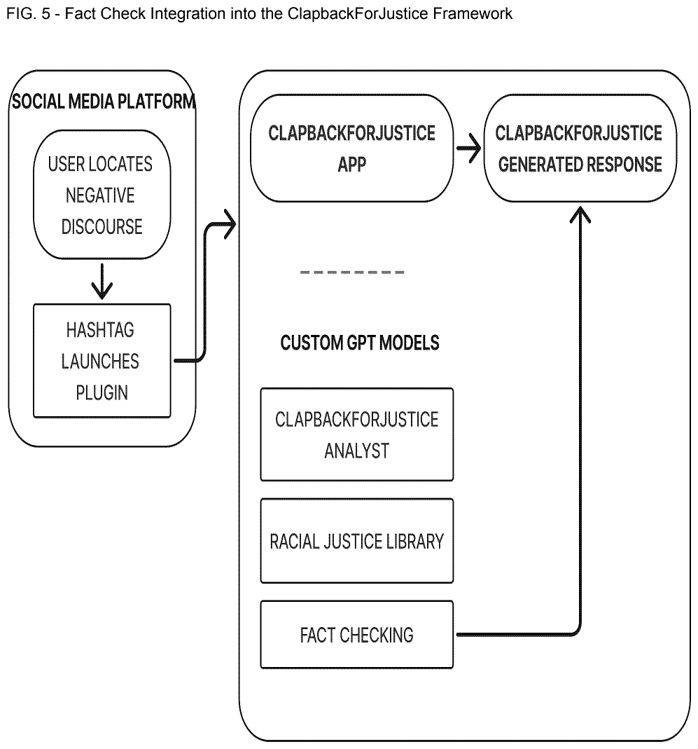

FIG. 6 Shows the feedback and continuous learning mechanism used to refine the system over time.

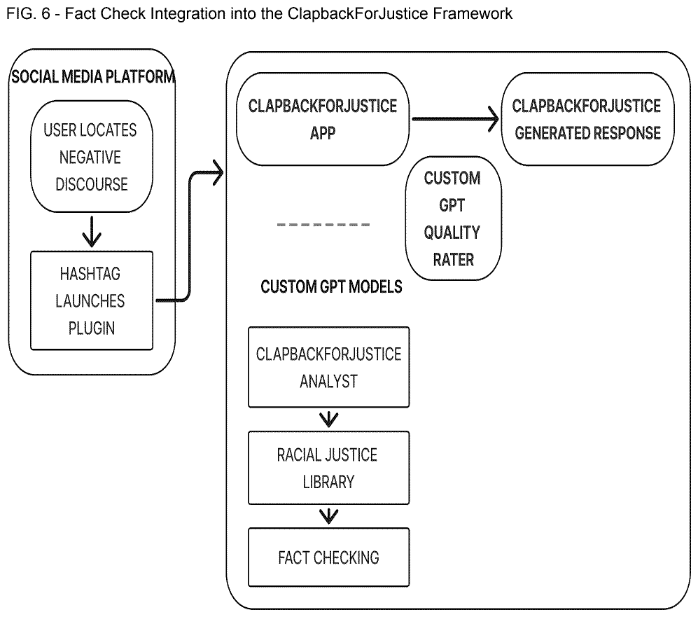

1. A method for analyzing and countering harmful racial content and racial misinformation in online discourse, comprising:
1. Receiving user-submitted content via a user interface.
2. Classifying the content using keyword and descriptor categorization.
3. Analyzing the content using custom GPT AI models for indicators of hate speech, bias, toxicity, or misinformation.
4. Applying the Integrated Framework for Assessing Racial Discourse (IFARD) to perform contextual and sociological evaluation.
5. Retrieving factual and historical data from a Racial Justice Data Library.
6. Fact-checking the content using external sources including news and social media.
7. Generating a counterargument using a counterargument generation module.
8. Applying quality assurance using a GPT Rater.
9. Presenting the counterargument and data visualizations to the user.

2. The method of claim 1, further comprising collecting user feedback for refining the system through a continuous learning process.

3. The method of claim 1, wherein bias mitigation algorithms are applied throughout the analysis and generation process.

4. The method of claim 1, wherein the system supports multilingual content analysis and response generation.

5. The method of claim 1, wherein the counterargument includes data visualizations that reference verified historical and contextual information.

6. The method of claim 1, further comprising presenting the counterargument in a format optimized for social media platforms. The method of claim 1, wherein the user interface is a web-based or mobile application.
